(19) United States
(12) Patent Application Publication
(10) Pub. No.: US 2024/0258815 A1
(43) Pub. Date: Aug. 1, 2024

(54) CHARGE CONTROL DEVICE, ELECTRICITY STORAGE SYSTEM, AND CHARGING METHOD

(71) Applicant: HONDA MOTOR CO., LTD., Tokyo (JP)

(72) Inventor: Takeshi FUJINO, Saitama (JP)

(21) Appl. No.: 18/423,314

(22) Filed: Jan. 26, 2024

(30) Foreign Application Priority Data
Jan. 31, 2023 (JP) 2023-013102

(51) Int. Cl. H02J 7/00; H01M 10/052; H01M 10/46

(52) U.S. Cl. CPC H02J 7/00712; H01M 10/052; H01M 10/46; H02J 7/0048

(57) ABSTRACT

The charge control device of the present invention includes a charging condition setter that compares a State of Charge (SOC) actual value being a current SOC value of a battery with a rapid charging start SOC value being an SOC value of the battery at a time of previously starting rapid charging by an external power source, and sets a first charging condition when the SOC actual value is equal to or less than the rapid charging start SOC value; and a charge controller that charges the battery under a charging condition that is set by the charging condition setter.

This application is based on and claims the benefit of priority from Japanese Patent Application No. 2023-013102, filed on 31 Jan. 2023, the content of which is incorporated herein by reference.

### BACKGROUND OF THE INVENTION

### Field of the Invention

The present invention relates to a charge control device, an electricity storage system, and a charging method.

### Related Art

In recent years, research and development have been conducted on charge control devices for secondary batteries to contribute to energy efficiency; this is aimed at ensuring more people have access to affordable, reliable, sustainable, and advanced energy.

For instance, in the case of charge control devices for lithium-ion secondary batteries, a study has been conducted on controlling the charging current to allow lithium to be deposited on the negative electrode, in which lithium is expected to dissolve after ending the charging (Patent Document 1).
Patent Document 1: Japanese Patent No. 7073837

### SUMMARY OF THE INVENTION

In the technology related to battery charge control devices, the challenge is to reduce charging time. However, charging the battery with a large current can lead to a decrease in the discharge capacity of the battery. Particularly, in lithium secondary batteries including metallic lithium as the negative electrode active material, rapid charging tends to form a porous, low-density lithium layer at the negative electrode. If the lithium layer formed during charging is of low density, it may increase the thickness of the negative electrode during charging, potentially increasing the overall thickness of the lithium secondary battery. Moreover, rapid charging in this state of low-density lithium layer formation further reduces the density of the deposited metallic lithium. This causes the metallic lithium to react more readily with the electrolyte, reducing the amount of active metallic lithium and contributing less to discharge.

An object of the present application is to provide a charge control device, an electricity storage system, and a charging method capable of rapid charging while suppressing a reduction in discharge capacity. This, in turn, contributes to the efficiency of the battery's utilized energy.

The inventors have completed the present invention by discovering that the aforementioned problems can be solved by setting permitted charging current/power values that are appropriate for a battery, based on the State of Charge (SOC) actual value being an SOC value of the battery and the rapid charging start SOC value being an SOC value of the battery at the time of previously starting rapid charging of the battery by an external power source. Thus, the present invention provides the following configurations of a charge control device, an electricity storage system, and a charging method:

(1) A charge control device, which includes: a charging condition setter that compares a State of Charge (SOC) actual value being a current SOC value of a battery with a rapid charging start SOC value being an SOC value of the battery at a time of previously starting rapid charging by an external power source, and sets a first charging condition when the SOC actual value is equal to or less than the rapid charging start SOC value; and a charge controller that charges the battery under a charging condition that is set by the charging condition setter.

According to the charge control device of (1), by comparing the battery's SOC actual value with the recorded rapid charging start SOC value, if the SOC actual value is equal to or less than the rapid charging start SOC value, rapid charging is performed under the first charging condition.

(2) The charge control device as described in (1), in which when the SOC actual value is higher than the rapid charging start SOC value, the charging condition setter sets a second charging condition with a rapid charging current value lower than in the first charging condition.

According to the charge control device of (2), if the SOC actual value is higher than the rapid charging start SOC value, charging is performed under the second charging condition, which has a reduced charging rate compared to the first charging condition, thus allowing for suppressing a reduction in discharge capacity.

(3) The charge control device as described in (1), in which when the SOC actual value becomes equal to or less than the rapid charging start SOC value, the charging condition setter resets the rapid charging start SOC value and sets the first charging condition.

According to the charge control device of (3), when the SOC actual value becomes equal to or less than the rapid charging start SOC value, the rapid charging start SOC value is reset, and the battery is charged under the first charging condition, enabling more reliable rapid charging.

(4) An electricity storage system, which includes: a battery; an SOC acquirer that acquires an SOC value of the battery; and a charge control device for the battery, in which the charge control device is the charge control device as described in any one of (1) to (3).

According to the electricity storage system of (4), the charge control device is the charge control device as described in any one of (1) to (3), thus enabling rapid charging of the battery while suppressing a reduction in discharge capacity.

(5) The electricity storage system as described in (4), in which the battery is a lithium secondary battery having a negative electrode allowing metallic lithium to be deposited by charging.

According to the electricity storage system of (5), since the battery is a lithium secondary battery having a negative electrode allowing metallic lithium to be deposited by charging, the capacity per unit volume of the battery is large.

(6) A charging method, which includes: a comparison step of comparing a State of Charge (SOC) actual value being a current SOC value of a battery with a rapid charging start SOC value being an SOC value of the battery at a time of previously starting rapid charging by an external power source; a charging condition setting step of setting a first charging condition when the SOC actual value is equal to or less than the rapid charging start SOC value, and setting a second charging condition with a rapid charging current value lower than in the first charging condition, when the SOC actual value is higher than the rapid charging start SOC value; and a charging step of charging the battery under a charging condition that is set in the charging condition setting step.

According to the charging method of (6), if the SOC actual value is equal to or less than the rapid charging start SOC value, the battery is charged under the first charging condition that includes rapid charging; if the SOC actual value is higher than the rapid charging start SOC value, the battery is charged under the second charging condition that has a lower charging current value than in the first charging condition, thus enabling rapid charging of the battery while suppressing a reduction in discharge capacity.

According to the present invention, it is possible to provide a charge control device, an electricity storage system, and a charging method, which can rapidly charge a battery while suppressing a reduction in discharge capacity.

### BRIEF DESCRIPTION OF THE DRAWINGS

FIG. 1 is a block diagram illustrating an electricity storage system according to an embodiment of the present invention;

FIG. 2 is a flowchart illustrating a charging method according to an embodiment of the present invention;

FIG. 3A is a schematic cross-sectional view illustrating the state of a negative electrode of a lithium secondary battery charged in accordance with a charging method of an embodiment of the present invention; and

FIG. 3B is a schematic cross-sectional view illustrating the state of a negative electrode of a lithium secondary battery charged in accordance with a conventional charging method.

### DETAILED DESCRIPTION OF THE INVENTION

Hereinafter, embodiments of the present invention will be described with reference to the drawings. However, the following embodiments are illustrative of the present invention and are not intended to limit the scope of the present invention.

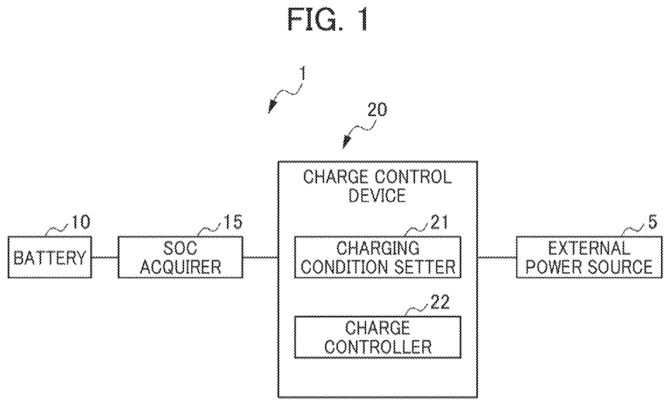

As illustrated in FIG. 1, the electricity storage system 1 of the present embodiment includes a battery 10, a State of Charge (SOC) acquirer 15 connected to the battery 10, and a charge control device 20 connected to the SOC acquirer 15. The charge control device 20 is connected to an external power source 5. The charge control device 20 charges the battery 10 with power supplied from the external power source 5.

The battery 10 is, for example, a lithium secondary battery. The lithium secondary battery includes a positive electrode, a negative electrode, a separator placed between the positive and negative electrodes, and an electrolyte solution. A solid electrolyte may be used instead of the electrolyte solution and separator.

The positive electrode includes a positive electrode current collector layer and a positive electrode active material layer. Aluminum, for example, can be used as the material for the positive electrode current collector layer. The positive electrode active material layer contains a positive electrode active material. Examples of the positive electrode active material may include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), hetero-element substituted Li—Mn spinel represented by Li₁₊ₓMn_{2-x-y}M_{y}O₄ (x+y=2, M is at least one selected from Al, Mg, Co, Fe, Ni, and Zn), lithium titanate (oxide containing Li and Ti), and metallic lithium phosphate (LiMPO₄, M is at least one selected from Fe, Mn, Co, and Ni). The positive electrode active material layer may include various additives used as materials for the positive electrode active material layer, such as a binder and a conductive aid.

The negative electrode includes a negative electrode current collector layer and a negative electrode active material layer. Copper, for example, can be used as the material for the negative electrode current collector layer. The negative electrode active material layer contains a negative electrode active material. Lithium or a metal that forms an alloy with lithium can be used as the negative electrode active material. Examples of metals that form alloys with lithium may include Mg, Si, Au, Ag, In, Ge, Sn, Pb, Al, and Zn. The negative electrode active material may also include carbonaceous materials. Examples of carbonaceous materials may include natural graphite, artificial graphite, mesocarbon microbeads (MCMB), hard carbon, and soft carbon.

The electrolyte solution contains an organic solvent and an electrolyte. Examples of organic solvents may include cyclic carbonates, chain carbonates, cyclic ethers, chain ethers, hydrofluoroethers, aromatic ethers, sulfones, cyclic esters, chain carboxylic acid esters, and nitriles. Examples of cyclic carbonates may include ethylene carbonate, propylene carbonate, vinylene carbonate, fluoroethylene carbonate, etc. Examples of chain carbonates may include dimethyl carbonate, diethyl carbonate, ethyl methyl carbonate, etc. Examples of cyclic ethers may include tetrahydrofuran, 2-methyltetrahydrofuran, tetrahydropyran, 1,3-dioxolane, 4-methyl-1,3-dioxolane, etc. Examples of chain ethers may include 1,2-dimethoxyethane, 1,2-diethoxyethane, ethoxymethoxyethane, diethyl ether, etc. Examples of hydrofluoroethers may include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, 1,2-bis(1,1,2,2-tetrafluoroethoxy) ethane, etc. An example of aromatic ethers may be anisole. Examples of sulfones may include sulfolane, methyl sulfolane, etc. Examples of cyclic esters may include γ-butyrolactone, etc. Examples of chain carboxylic acid esters may include acetate esters, butyrate esters, propionate esters, etc. Examples of nitriles may include acetonitrile, propionitrile, etc. The organic solvent may be used alone or in combination with two or more types.

The electrolyte, serving as a source of lithium ions which are charge transfer media, includes lithium salts. Examples of lithium salts may include LiPF₆, LiBF₄, LiClO₄, LiAsF₆, LiCF₃SO₃, LiC(CF₃SO₂)₃, LIN(CF₃SO₂)₂ (LiTFSI), LIN (FSO₂)₂ (LiFSI), LiBC₄O₈, etc. The lithium salt can be used alone or in combination with two or more types.

Sulfide-based solid electrolytes, for example, can be used as solid electrolytes. Examples of sulfide-based solid electrolytes may include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m, n are positive numbers; Z is either Ge, Zn, or Ga), Li₂S—GeS₂, Li₂S—SiS₂—Li₃PO₄, Li₂S—SiS₂-LiₓMO_{y} (where x, y are positive numbers; M is either P, Si, Ge, B, Al, Ga, or In), etc.

Materials composing the separator are not particularly limited and can include, for example, polyolefins such as polyethylene and polypropylene, aramids, polyimides, fluoropolymers, glass fibers, cellulose fibers, etc.

The SOC acquirer 15 acquires the SOC actual value as the current SOC value of the battery 10. There are no particular restrictions on the method of calculating the SOC actual value; for example, the method of measuring the Open Circuit Voltage (OCV) of the battery 10, using this result to further obtain an OCV value, and estimating the SOC from this OCV value and an SOC-OCV curve can be used. The SOC acquirer 15 may be configured to acquire the SOC actual value of the battery 10 both before and during charging. Additionally, the SOC acquirer 15 may be configured to acquire the SOC actual value of the battery 10 continuously or intermittently during discharge. Furthermore, the SOC actual value may be calculated by combining the electrical power which is computed by accumulating the OCV value and the current value.

The charge control device 20 includes a charging condition setter 21 and a charge controller 22. The charge control device 20 of the present embodiment is, for example, incorporated in a Battery Management Unit (BMU).

The charging condition setter 21 stores the rapid charging start SOC value and a plurality of rapid charging conditions based on the degradation state of the battery 10. Furthermore, the charging condition setter 21 may store the rapid charging end SOC value or the rapid charging interval. The rapid charging start SOC value is the lower limit value of the SOC actual values of the battery 10 when the battery 10 was previously rapidly charged by the external power source 5, and is the SOC actual value when the rapid charging started. The rapid charging end SOC value is the upper limit value of the SOC actual values of the battery 10 when the battery 10 was previously rapidly charged by the external power source 5, and is the SOC actual value when the rapid charging ended. The rapid charging interval is the range of SOC values of the battery 10 when the battery 10 was previously rapidly charged by the external power source 5, and is the value obtained by subtracting the rapid charging start SOC value from the rapid charging end SOC value. The rapid charging conditions, for instance, are conditions that can be accepted by the battery 10 when the battery 10 is rapidly charged by the external power source 5 at a certain temperature and SOC value. The rapid charging conditions may be a table or formula of limit values for the charging current values or power values. It is preferable that the charging condition setter 21 stores at least two types of charging conditions: the first charging condition used when the SOC actual value of the pre-charging battery 10 is equal to or less than the rapid charging start SOC value, and the second charging condition used when the SOC actual value of the pre-charging battery 10 is higher than the rapid charging start SOC value. The first charging condition, for example, is the condition with the highest charging current value among the rapid charging conditions stored in the charging condition setter 21. The second charging condition is the condition with a lower charging current value during rapid charging, than the first charging condition. The conditions set in the first and second charging conditions may be, for example, the SOC interval for rapid charging and the charging current value for that SOC interval. The SOC interval for rapid charging is not particularly limited but is preferably within a range of 10% or more to less than 90%, more preferably within a range of 15% or more to less than 75%. The SOC interval and the charging current values are adjusted based on the standard of the external power source 5, the capacity of the battery 10, and the type of the battery 10. The charging current value is, for example, equal to or less than the maximum current value of the external power source 5, and can be set considering the heat generation and durability of the battery 10. In the second charging condition, for example, the charging current value may be adjusted based on the previous rapid charging interval. In this case, the charging current value of the second charging condition is set such that the difference with the first charging condition becomes smaller as the previous rapid charging interval is shorter. Rapid charging refers to charging with direct current through a direct current charging connector from the external power source 5, and can be performed using the standards such as COMBO or CHAdeMO.

The charge controller 22 controls the current or power when the battery 10 is charged with the external power source 5. When the charge controller 22 charges the battery 10 under the first charging condition, it is preferable for the charging condition setter 21 to store the SOC actual value at the time of starting rapid charging as a new rapid charging start SOC value and to overwrite this rapid charging start SOC value when the SOC actual value reaches the rapid charging end SOC value. Additionally, when the SOC actual value falls below the rapid charging start SOC value, the rapid charging start SOC value stored in the charging condition setter 21 may be reset. When the rapid charging start SOC value is reset, it is preferable for the charging condition setter 21 to acquire and store the rapid charging start SOC value when the battery 10 is rapidly charged under the first charging condition after the reset.

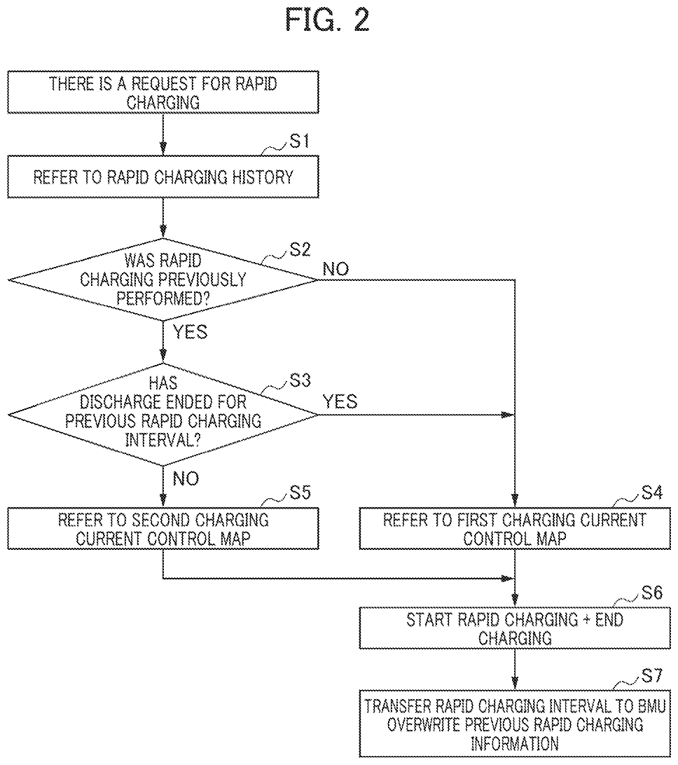

Next, the method of charging the battery 10 using the charge control device 20 is described with reference to FIG. 2. First, when the charge control device 20 determines that there is a request for rapid charging, it refers to the rapid charging history (first Step S1). Then, the charge control device 20 determines whether rapid charging was previously performed (second Step S2). If it is determined in the second Step S2 that rapid charging was previously performed (YES), the processing proceeds to the third Step S3. The third Step S3 is a step of comparing the SOC actual value with the rapid charging start SOC value (comparison step). If the SOC actual value is below or equal to the rapid charging start SOC value, it is determined that the discharge has ended for the previous rapid charging interval. If it is determined in the third Step S3 that the discharge has ended for the previous rapid charging interval (YES), the processing proceeds to the fourth Step S4. Also, if it is determined in the second Step S2 that rapid charging was not previously performed (NO), the processing also proceeds to the fourth Step S4. The fourth Step S4 is a step of setting the first charging condition by referring to the first charging current control map (charging condition setting step).

If it is determined in the third Step S3 that the discharge has not ended for the previous rapid charging interval, i.e., the SOC actual value is higher than the rapid charging start SOC value (NO), the processing proceeds to the fifth Step S5. The fifth Step S5 is a step of setting the second charging condition by referring to the second charging current control map (charging condition setting step). Once the charging condition is set in the fourth Step 4 or fifth Step 5, the processing proceeds to the sixth Step S6.

The sixth Step S6 is a step of charging based on the charging conditions set in the fourth Step 4 or fifth Step 5 (charging step). Then, in the seventh Step S7, the rapid charging interval (the rapid charging start SOC value and the rapid charging end SOC value) is transferred to the BMU and saved in the charging condition setter 21 incorporated in the BMU.

The charging method of the present embodiment is described with specific examples. The conditions set in the current control map for the first and second charging conditions used in the present embodiment are illustrated in the following table. The current control map is recorded in the charging condition setter 21.

TABLE 1

| | PERMITTED | | | | | |
|---|---|---|---|---|---|---|
| | CHARGING | | | | | |
| | CURRENT VALUE | | | | | |
| | OF FIRST | PERMITTED CHARGING CURRENT VALUE OF | | | | |
| | CHARGING | SECOND CHARGING CONDITION (A) | | | | |
| | CONDITION | PREVIOUS RAPID CHARGING INTERVALS | | | | |
| SOC INTERVAL | (A) | Δ 50% | Δ 40% | Δ 30% | Δ 20% | Δ 10% |
| SOCO-SOC15 | 150 | 150 | 150 | 150 | 150 | 150 |
| SOC15-SOC30 | 400 | 240 | 280 | 320 | 360 | 400 |
| SOC30-SOC45 | 300 | 218 | 240 | 263 | 285 | 300 |
| SOC45-SOC60 | 200 | 150 | 160 | 170 | 180 | 200 |
| SOC60-SOC75 | 150 | 122 | 128 | 133 | 139 | 150 |
| SOC75-SOC100 | 125 | 125 | 125 | 125 | 125 | 125 |

As illustrated in the table above, the current control map is a current limitation map, in which the permitted charging current value for direct current (DC) charging is set for each SOC interval of the battery 10. In this current limitation map, the intervals for the SOC values between 15% or more and less than 75% are designated as the intervals for rapid charging. The interval for the SOC of less than 15% is designated as an interval for normal charging with a permitted charging current value of 150 A, and the interval for the SOC of 75% or more is designated as an interval for normal charging with a permitted charging current value of 125 A. Each permitted charging current value is the upper limit value of the current that the external power source 5 is permitted to supply to the battery 10. The first charging condition is set such that the permitted charging current values are switched by referring to each SOC interval. Additionally, the second charging condition is set such that the permitted charging current values are switched by referring to each SOC interval and the previous rapid charging interval (rapid charging end SOC value at the time of previously performing rapid charging-rapid charging start SOC value) when the previous DC charge was determined to be rapid charging. The previous rapid charging intervals are set at Δ10%, Δ20%, Δ30%, Δ40%, and Δ50%. Note that the SOC intervals, charging current values, and previous rapid charging intervals in the current limitation map are not limited to the values listed in the table.

(1) Case in which the battery 10 was rapidly charged until the SOC value reached from 15% to 75% in the previous charge, and then normally charged until the SOC value reached from 75% to 100% (previous rapid charging interval of Δ60%), and thereafter discharged until the SOC value fell to 10%, and then charged until the SOC value reached 100%:

Since the SOC value after discharge is 10%, and the previous rapid charging interval has ended, the determination in the third Step S3 is YES. Therefore, rapid charging is performed under the first charging condition. Specifically, normal charging is performed until the SOC value reaches from 10% to 15%, and once the SOC value exceeds 15%, rapid charging is performed with a charging current value that does not exceed the permitted charging current value. Once the SOC value reaches 75%, normal charging is performed. After the charging ends, the previous rapid charging interval of Δ60% (rapid charging start SOC value 15%, rapid charging end SOC value 75%) is saved in the charging condition setter 21.

(2) Case in which the battery 10 was rapidly charged until the SOC value reached from 15% to 55% in the previous charge (previous rapid charging interval of Δ40%), and then discharged until the SOC value fell to 10%, and then charged until the SOC value reached 100%:

Since the discharge was performed until the SOC value fell to 10%, the determination in the third Step S3 is YES, as in (1). Therefore, rapid charging is performed under the first charging condition. Specifically, normal charging is performed until the SOC value reaches from 10% to 15%, and once the SOC value exceeds 15%, rapid charging is performed with a charging current value that does not exceed the permitted charging current value, and once the SOC value reaches 75%, normal charging is performed. After the charging ends, the rapid charging interval of Δ60% (rapid charging start SOC value 15%, rapid charging end SOC value 75%) is saved in the charging condition setter 21.

(3) Case in which the battery 10 was rapidly charged until the SOC value reached from 15% to 55% in the previous charge (previous rapid charging interval of Δ40%), and then discharged until the SOC value fell to 30%, and then charged until the SOC value reached 100%:

Since the SOC value after discharge is 30%, and the previous rapid charging interval has not ended, the determination in the third Step S3 is NO. Therefore, rapid charging is performed under the second charging condition. Specifically, rapid charging is performed with a charging current value that does not exceed the permitted charging current value set under the second charging condition with the previous rapid charging interval of Δ40% until the SOC value reaches from 30% to 75%, and once the SOC value reaches 75%, normal charging is performed. After the charging ends, the rapid charging interval of Δ45% (rapid charging start SOC value 30%, rapid charging end SOC value 75%) is saved in the charging condition setter 21.

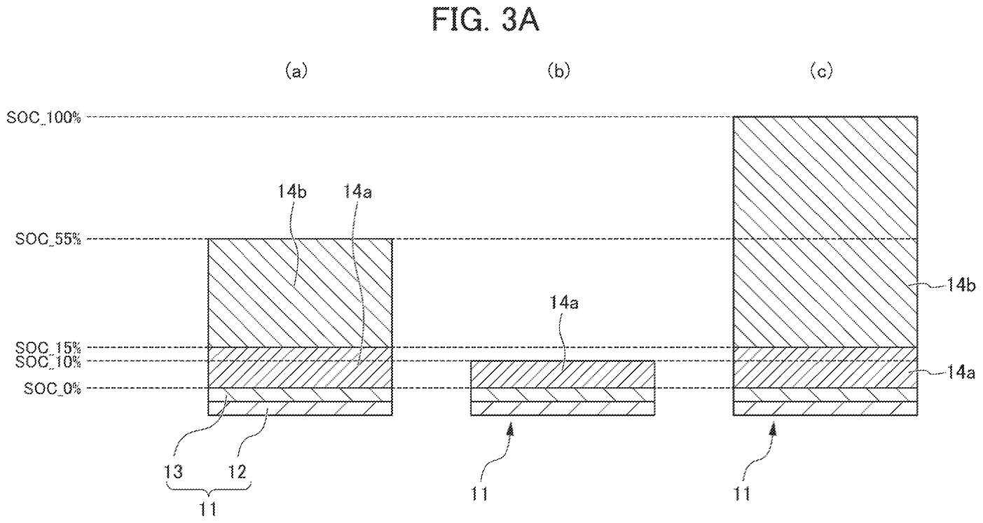

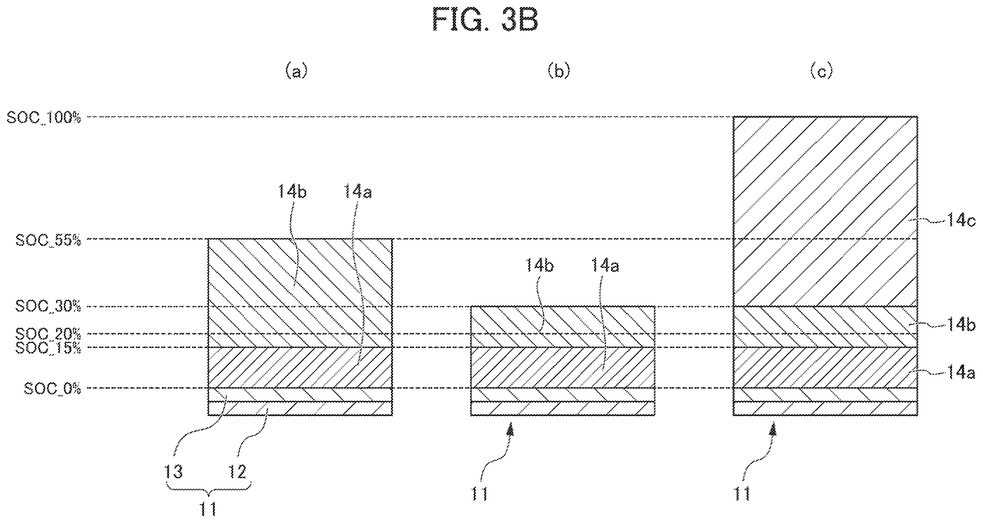

Next, the state of the negative electrode of the battery (lithium secondary battery) 10, which was charged using the charging method of the present embodiment, will be described using FIG. 3A. The negative electrode 11 illustrated in FIG. 3A is a stack, which includes the copper foil 12 as a current collector and the lithium foil 13 stacked on the surface of the copper foil 12.

Diagram (a) of FIG. 3A illustrates a schematic cross-sectional view of the negative electrode 11, in which the battery was normally charged from the SOC of 0% to 15%, and once the SOC reached 15%, the battery was rapidly charged up to the SOC of 55% under the first charging condition. Under this condition, the rapid charging start SOC value should be 15%. In this case, within the range of SOC (0%≤SOC<15%) where the battery 10 was normally charged, a high-density lithium layer 14a with few inclusions of pores was formed on the lithium foil 13. Within the range of SOC (15%≤SOC≤55%) where the battery 10 was rapidly charged under the first charging condition, the deposition rate of lithium increases, making it easier for fine pores to mix in. Thus, as compared to the high-density lithium layer 14a, a medium-density lithium layer 14b with internal fine pores and less dense lithium was formed.

Diagram (b) of FIG. 3A illustrates a schematic cross-sectional view of the negative electrode 11, in which the battery of (a) was discharged until the SOC value fell to 10%. As illustrated in (b) of FIG. 3A, when the battery was discharged until the SOC value fell below the rapid charging start SOC value, the medium-density lithium layer 14b in the negative electrode 11 disappeared. Diagram (c) of FIG. 3A illustrates a schematic cross-sectional view of the negative electrode 11, in which the battery of (b) was normally charged from the SOC value of 10% to 15%, and once the SOC value reached 15%, rapid charging was performed under the first charging condition, and once the SOC value reached 75%, normal charging was performed. As illustrated in (c) of FIG. 3A, since normal charging was performed until the SOC value reached 15%, the high-density lithium layer 14a was formed. Since the charging was performed under the first charging condition for the SOC value of 15% to 75%, and normal charging was performed for the SOC value of 75%, the medium-density lithium layer 14b was formed. In the charging method of the present embodiment, the medium-density lithium layer 14b is formed due to rapid charging, making it less likely for the battery 10 to experience a reduction in discharge capacity even when rapidly charged.

In contrast, with conventional charging methods that do not consider the rapid charging start SOC value of the battery 10, the discharge capacity of the battery 10 may be reduced when rapidly charged. Diagram (a) of FIG. 3B, which is similar to diagram (a) of FIG. 3A, illustrates a schematic cross-sectional view of the negative electrode 11, in which the battery was normally charged from the SOC of 0% to 15%, and once the SOC reached 15%, rapid charging was performed under the first charging condition up to the SOC of 55%. Diagram (b) of FIG. 3B illustrates a schematic cross-sectional view of the negative electrode 11, in which the battery of (a) was discharged until the SOC value fell to 30%. As illustrated in (b) of FIG. 3B, when the SOC value was equal to or higher than the rapid charging start SOC value, the medium-density lithium layer 14b remained in the negative electrode 11. With conventional charging methods, rapid charging may be performed when the SOC actual value of the battery 10 is higher than the rapid charging start SOC value. Diagram (c) of FIG. 3B illustrates a schematic cross-sectional view of the negative electrode 11, in which the battery of (b) was rapidly charged under the first charging condition, and once the SOC value reached 75%, normal charging was performed. As illustrated in (c) of FIG. 3B, a low-density lithium layer 14c was formed on the medium-density lithium layer 14b that remained after discharge. Lithium will not be deposited on the fine pores mixed into the medium-density lithium layer 14b. Therefore, a porous, low-density lithium layer 14c with more internal fine pores and less dense lithium than the medium-density lithium layer 14b is formed on the medium-density lithium layer 14b.

In the charging method of the present embodiment, when the SOC actual value of the battery 10 is higher than the rapid charging start SOC value of the battery 10, i.e., when the medium-density lithium layer 14b remains, the battery 10 is charged under the second charging condition with a charging current value that is lower than in the first charging condition. Therefore, the low-density lithium layer 14c is less likely to be formed on the medium-density lithium layer 14b.

With the charge control device 20 and the electricity storage system 1 of the present embodiment configured as above, when the SOC actual value of the battery 10 is equal to or smaller than the rapid charging start SOC value, the battery 10 is charged under the first charging condition; therefore, reduction in discharge capacity can be suppressed even when the battery 10 is rapidly charged. Moreover, when the SOC actual value is higher than the rapid charging start SOC value, the battery 10 is charged under the second charging condition with a charging current value that is lower than in the first charging condition; therefore, reduction in discharge capacity can be suppressed. Thus, the life of the battery 10 is extended. Especially, when the second charging condition is set for each previous rapid charging interval, which is the SOC interval of the previous rapid charging, the charging current value is further reduced; therefore, the life of the battery 10 is further extended. The charge control device 20 and the electricity storage system 1 of the present embodiment are effective for the case where the battery 10 is a lithium secondary battery having a negative electrode allowing metallic lithium to be deposited by charging.

Furthermore, with the charge control device 20 and the electricity storage system 1, the charge controller 22 overwrites the rapid charging start SOC value in the charging condition setter 21 with the lower limit value of the SOC at the time of charging the battery 10 under the first charging condition; therefore, the accuracy of the rapid charging start SOC value can be improved. Additionally, when the SOC actual value falls below the rapid charging start SOC value, the rapid charging start SOC value stored in the charging condition setter 21 is reset, and the battery is charged under the first charging condition, allowing for more reliable rapid charging.

Also, according to the charging method of the present embodiment, when the SOC actual value is equal to or smaller than the rapid charging start SOC value, the battery is charged under the first charging condition that includes rapid charging, and when the SOC actual value is higher than the rapid charging start SOC value, the battery is charged under the second charging condition that does not include rapid charging; therefore, the battery can be rapidly charged while suppressing a reduction in discharge capacity.

It should be noted that the present invention is not limited to the above embodiments, and the above embodiments may be appropriately modified within the spirit and scope of the present invention. In the charge control device 20 of the above embodiments, the charging condition setter 21 acquires and stores the rapid charging start SOC value and the charging conditions, but the present invention is not limited to this. For example, the rapid charging start SOC value and the charging conditions may be stored in an information terminal, and the charging condition setter 21 may serve as a charging condition acquirer that acquires the rapid charging start SOC value and the charging conditions from the information terminal when charging. The information terminal may be, for example, a smartphone, tablet, or personal computer.

The charge control device 20 of the present embodiment and the electricity storage system 1 with this charge control device 20 can be used, for example, as a power source for the motor of electrically powered vehicles such as electric cars and electric motorcycles. In the present embodiment, the charge control device 20 is incorporated in the BMU of a car, but the charge control device 20 does not necessarily have to be incorporated in the BMU of a car.

### EXPLANATION OF REFERENCE NUMERALS

1: electricity storage system
5: external power source
10: battery
11: negative electrode
12: copper foil
13: lithium foil
14a: high-density lithium layer
14b: medium-density lithium layer
14c: low-density lithium layer
15: SOC acquirer
20: charge control device
21: charging condition setter
22: charge controller

What is claimed is:

1. A charge control device, comprising:
a charging condition setter that compares a State of Charge (SOC) actual value being a current SOC value of a battery with a rapid charging start SOC value being an SOC value of the battery at a time of previously starting rapid charging by an external power source, and sets a first charging condition when the SOC actual value is equal to or less than the rapid charging start SOC value; and
a charge controller that charges the battery under a charging condition that is set by the charging condition setter.

2. The charge control device according to claim 1, wherein, when the SOC actual value is higher than the rapid charging start SOC value, the charging condition setter sets a second charging condition with a rapid charging current value lower than in the first charging condition.

3. The charge control device according to claim 1, wherein, when the SOC actual value becomes equal to or less than the rapid charging start SOC value, the charging condition setter resets the rapid charging start SOC value and sets the first charging condition.

4. An electricity storage system, comprising: a battery; an SOC acquirer that acquires an SOC value of the battery; and a charge control device for the battery,
wherein the charge control device is the charge control device according to claim 1.

5. The electricity storage system according to claim 4, wherein the battery is a lithium secondary battery having a negative electrode allowing metallic lithium to be deposited by charging.

6. A charging method, comprising:
a comparison step of comparing a State of Charge (SOC) actual value being a current SOC value of a battery with a rapid charging start SOC value being an SOC value of the battery at a time of previously starting rapid charging by an external power source;
a charging condition setting step of setting a first charging condition when the SOC actual value is equal to or less than the rapid charging start SOC value, and setting a second charging condition with a rapid charging current value lower than in the first charging condition, when the SOC actual value is higher than the rapid charging start SOC value; and
a charging step of charging the battery under a charging condition that is set in the charging condition setting step.
